(19) United States
(12) Patent Application Publication
(10) Pub. No.: US 2005/0029704 A1
(43) Pub. Date: Feb. 10, 2005

(54) Method for manufacturing a sealable bag having an indicia for use in vacuum packaging

(75) Inventors: Hongyu Wu, San Jose, CA (US); Charles Wade Albritton, Hercules, CA (US); David Brakes, Kowloon (CN)

Correspondence Address: FLIESLER MEYER, LLP, FOUR EMBARCADERO CENTER, SUITE 400, SAN FRANCISCO, CA, 94111, US

(73) Assignee: Tilia International, Inc., San Francisco, CA (US)

(21) Appl. No.: 10/794,351

(22) Filed: Mar. 4, 2004

Related U.S. Application Data
(60) Provisional application No. 60/451,948, filed on Mar. 5, 2003.
(60) Provisional application No. 60/452,168, filed on Mar. 5, 2003.
(60) Provisional application No. 60/452,138, filed on Mar. 5, 2003.
(60) Provisional application No. 60/452,172, filed on Mar. 5, 2003.
(60) Provisional application No. 60/452,171, filed on Mar. 5, 2003.
(60) Provisional application No. 60/451,954, filed on Mar. 5, 2003.
(60) Provisional application No. 60/452,142, filed on Mar. 5, 2003.
(60) Provisional application No. 60/452,021, filed on Mar. 5, 2003.
(60) Provisional application No. 60/451,955, filed on Mar. 5, 2003.
(60) Provisional application No. 60/451,956, filed on Mar. 5, 2003.
(60) Provisional application No. 60/452,157, filed on Mar. 5, 2003.
(60) Provisional application No. 60/452,139, filed on Mar. 5, 2003.

(51) Int. Cl. B29C 43/22

(52) U.S. Cl. 264/166; 264/175; 264/284

(57) ABSTRACT

A method for manufacturing a bag for use in vacuum packaging comprises forming a first panel having an indicia for communicating informafion to a user and a second panel. Each panel comprises a gas-impermeable base layer and a heat-sealable inner layer molded from melt-extruded resin. Optionally, the method further comprises forming a colored indicia such that the indicia is more visible to a user. The first panel is overlapped with the second panel, and three of four edges of the panels are heated such that the inner layers bond at the heated edges. This description is not intended to be a complete description of, or limit the scope of, the invention. Other features, aspects, and objects of the invention can be obtained from a review of the specification, the figures, and the claims.

### PRIORITY CLAIM

This application claims priority to the following U.S. Provisional Patent Application:

U.S. Provisional Patent Application No. 60/451,948, entitled “METHOD FOR MANUFACTURING A SEALABLE BAG HAVING AN INDICIA FOR USE IN VACUUM PACKAGING,” by Henry Wu, et al., filed Mar. 5, 2003 (Attorney Docket No. TILA-01179US1).

### CROSS-REFERENCE TO RELATED PATENT APPLICATIONS

This U.S. Patent Application incorporates by reference all of the following co-pending applications:

U.S. Provisional Patent Application No. 60/452,168, entitled “LIQUID-TRAPPING BAG FOR USE IN VACUUM PACKAGING,” by Henry Wu, et al., filed Mar. 5, 2003 (Attorney Docket No. TILA-01177US0);

U.S. Provisional Patent Application No. 60/452,138, entitled “METHOD FOR MANUFACTURING LIQUID-TRAPPING BAG FOR USE IN VACUUM PACKAGING,” by Henry Wu, et al., filed Mar. 5, 2003 (Attorney Docket No. TILA-01177US1);

U.S. Provisional Patent Application No. 60/452,172, entitled “SEALABLE BAG HAVING AN INTEGRATED TRAY FOR USE IN VACUUM PACKAGING,” by Henry Wu, et al., filed Mar. 5, 2003 (Attorney Docket No. TILA-01178US0);

U.S. Provisional Patent Application No. 60/452,171, entitled “METHOD FOR MANUFACTURING A SEALABLE BAG HAVING AN INTEGRATED TRAY FOR USE IN VACUUM PACKAGING,” by Henry Wu, et al., filed Mar. 5, 2003 (Attorney Docket No. TILA-01178US1);

U.S. Provisional Patent Application No. 60/451,954, entitled “SEALABLE BAG HAVING AN INDICIA FOR USE IN VACUUM PACKAGING,” by Henry Wu, et al., filed Mar. 5, 2003 (Attorney Docket No. TILA-01179US0);

U.S. Provisional Patent Application No. 60/452,142, entitled “SEALABLE BAG HAVING AN INTEGRATED ZIPPER FOR USE IN VACUUM PACKAGING,” by Henry Wu, et al., filed Mar. 5, 2003 (Attorney Docket No. TILA-01180US0);

U.S. Provisional Patent Application No. 60/452,021, entitled “METHOD FOR MANUFACTURING A SEALABLE BAG HAVING AN INTEGRATED ZIPPER FOR USE IN VACUUM PACKAGING,” by Henry Wu, et al., filed Mar. 5, 2003 (Attorney Docket No. TILA-01180US1);

U.S. Provisional Patent Application No. 60/451,955, entitled “SEALABLE BAG HAVING AN INTEGRATED VALVE STRUCTURE FOR USE IN VACUUM PACKAGING,” by Henry Wu, et al., filed Mar. 5, 2003 (Attorney Docket No. TILA-01181US0);

U.S. Provisional Patent Application No. 60/451,956, entitled “METHOD FOR MANUFACTURING A SEALABLE BAG HAVING AN INTEGRATED VALVE STRUCTURE FOR USE IN VACUUM PACKAGING,” by Henry Wu, et al., filed Mar. 5, 2003 (Attorney Docket No. TILA-01181US1);

U.S. Provisional Patent Application No. 60/452,157, entitled “SEALABLE BAG HAVING AN INTEGRATED TIMER/SENSOR FOR USE IN VACUUM PACKAGING,” by Henry Wu, et al., filed Mar. 5, 2003 (Attorney Docket No. TILA-01182US0);

U.S. Provisional Patent Application No. 60/452,139, entitled “METHOD FOR MANUFACTURING A SEALABLE BAG HAVING AN INTEGRATED TIMER/SENSOR FOR USE IN VACUUM PACKAGING,” by Henry Wu, et al., filed Mar. 5, 2003 (Attorney Docket No. TILA-01182US1);

U.S. patent application Ser. No. 10/169,485, entitled “METHOD FOR PREPARING AIR CHANNEL EQUIPPED FILM FOR USE IN VACUUM PACKAGE”, filed Jun. 26, 2002;

U.S. patent application Ser. No.______, entitled “LIQUID-TRAPPING BAG FOR USE IN VACUUM PACKAGING,” Attorney Docket No. TILA-01177US2, filed concurrently;

U.S. patent application Ser. No.______, entitled “METHOD FOR MANUFACTURING LIQUID-TRAPPING BAG FOR USE IN VACUUM PACKAGING,” Attorney Docket No. TILA-01177US3, filed concurrently;

U.S. patent application Ser. No.______, entitled “SEALABLE BAG HAVING AN INTEGRATED TRAY FOR USE IN VACUUM PACKAGING,” Attorney Docket No. TILA-b 01178US2, filed concurrently;

U.S. patent application Ser. No.______, entitled “METHOD FOR MANUFACTURING A SEALABLE BAG HAVING AN INTEGRATED TRAY FOR USE IN VACUUM PACKAGING,”Attorney Docket No. TILA-01178US3, filed concurrently;

U.S. patent application Ser. No.______, entitled “SEALABLE BAG HAVING AN INDICIA FOR USE IN VACUUM PACKAGING,” Attorney Docket No. TILA-01179US2, filed concurrently;

U.S. patent application Ser. No.______, entitled “SEALABLE BAG HAVING AN INTEGRATED ZIPPER FOR USE IN VACUUM PACKAGING,” Attorney Docket No. TILA-01180US2, filed concurrently;

U.S. patent application Ser. No.______, entitled “METHOD FOR MANUFACTURING A SEALABLE BAG HAVING AN INTEGRATED ZIPPER FOR USE IN VACUUM PACKAGING,” Attorney Docket No. TILA-01180US3, filed concurrently;

U.S. patent application Ser. No.______, entitled “SEALABLE BAG HAVING AN INTEGRATED VALVE STRUCTURE FOR USE IN VACUUM PACKAGING,” Attorney Docket No. TILA-01181US2, filed concurrently;

U.S. patent application Ser. No.______, entitled “METHOD FOR MANUFACTURING A SEALABLE BAG HAVING AN INTEGRATED VALVE STRUCTURE FOR USE IN VACUUM PACKAGING,” Attorney Docket No. TILA-01181US3, filed concurrently;

U.S. patent application Ser. No.______, entitled “SEALABLE BAG HAVING AN INTEGRATED TIMER/SENSOR FOR USE IN VACUUM PACKAGING,” Attorney Docket No. TILA-01182US2, filed concurrently; and

U.S. patent application Ser. No.______, entitled “METHOD FOR MANUFACTURING A SEALABLE BAG HAVING AN INTEGRATED TIMER/SENSOR FOR USE IN VACUUM PACKAGING,” Attorney Docket No. TILA-01182US3, filed concurrently.

### FIELD OF THE INVENTION

The present invention relates to bags for use in vacuum packaging and methods and devices for manufacturing bags for use in vacuum packaging.

### BACKGROUND

Methods and devices for preserving perishable foods such as fish and meats, processed foods, prepared meals, and left-overs, and non-perishable items are widely known, and widely varied. Foods are perishable because organisms such as bacteria, fungus and mold grow over time after a food container is opened and the food is left exposed to the atmosphere. Most methods and devices preserve food by protecting food from organism-filled air. A common method and device includes placing food into a gas-impermeable plastic bag, evacuating the air from the bag using suction from a vacuum pump or other suction source, and tightly sealing the bag.

A bag for use in vacuum packaging can consist of a first panel and second panel, each panel consisting of a single layer of heat-sealable, plastic-based film (for example, polyethylene). The panels are sealed together along a substantial portion of the periphery of the panels by heat-sealing techniques so as to form an envelope. Perishable products, such as spoilable food, or other products are packed into the envelope via the unsealed portion through which air is subsequently evacuated. After perishable products are packed into the bag and air is evacuated from the inside of the bag, the unsealed portion is heated and pressed such that the panels adhere to each other, sealing the bag.

U.S. Pat. No. 2,778,173, incorporated herein by reference, discloses a method for improving the evacuation of air from the bag by forming channels in at least one of the panels with the aid of embossing techniques. Air escapes from the bag along the channels during evacuation. The embossing forms a pattern of protuberances on at least one of the panels. The protuberances can be discrete pyramids, hemispheres, etc., and are formed by pressing a panel using heated female and male dies. The first panel is overlaid on the second panel such that the protuberances from one panel face the opposite panel. The contacting peripheral edges of the panels are sealed to each other to form an envelope having an inlet at an unsealed portion of the periphery. The perishable or other products are packed into the envelope through the inlet, and the inlet is sealed. Thereafter, an opening is pierced in a part of the panel material that communicates with the channels, air is removed from the interior of the envelope through the channels and opening, and the opening is sealed. This type of bag requires two additional sealing steps after the perishable or other product is packed into the envelope. One further problem is that embossing creates impressions on the plastic such that indentations are formed on the opposite side of the panel

To avoid additional sealing steps, a vacuum bag is formed having a first panel and a second panel consisting of laminated films. Each panel comprises a heat-sealable inner layer, a gas-impermeable outer layer, and optionally, one or more intermediate layers. Such a bag is described in U. S. Pat. No. Re. 34,929, incorporated herein by reference. At least one film from at least one panel is embossed using an embossing mold to form protuberances and channels defined by the space between protuberances, so that air is readily evacuated from the vacuum bag.

U.S. Pat. No. 5,554,423, incorporated herein by reference, discloses still another bag usable in vacuum packaging. The bag consists of a first and second panel, each panel consisting of a gas-impermeable outer layer and a heat-sealable inner layer. A plurality of heat-sealable strand elements are heat bonded at regular intervals to the inner layer of either the first panel or the second panel. The spaces between strand elements act as channels for the evacuation of air. The strand elements are extruded from an extrusion head and heat bonded to the heat-sealable layer by use of pressure rolls. Separate equipment is required for producing strand elements, and a procedure of heat bonding a plurality of strand elements at regular intervals to the heat-sealable inner layer is complicated. Also, various shapes of pattern are hard to form using this process.

### BRIEF DESCRIPTION OF THE FIGURES

Further details of embodiments of the present invention are explained with the help of the attached drawings in which:

FIG. 1A is a perspective view of a method for manufacturing a vacuum bag in accordance with one embodiment of the present invention;

FIG. 1B is a side view of the method shown in FIG. 1A illustrating the embossing method used in an embodiment of the present invention;

FIG. 1C is a close-up view of a portion of FIG. 1B;

FIGS. 2A-C are plan views of exemplary indicia on a panel in accordance with embodiments of the present invention, manufactured by the process shown in FIGS. 1A and B;

FIG. 3A is a cross-section of a portion of a first panel as illustrated in FIG. 2B, overlapping a second panel of an embodiment of the present invention, wherein the indicia are indented into the inner layer;

FIG. 3B is a cross-section of a portion of a first panel as illustrated in FIG. 2B, overlapping a second panel of an embodiment of the present invention, wherein the indicia are protuberances;

FIG. 4A is a perspective view of a method for manufacturing a vacuum bag having colored indicia in accordance with one embodiment of the present invention;

FIG. 4B is a perspective view of a method for manufacturing a vacuum bag having colored indicia in accordance with an alternative embodiment of the present invention; and

FIG. 5 is a perspective view of a vacuum bag in accordance with one embodiment of the present invention.

### DETAILED DESCRIPTION

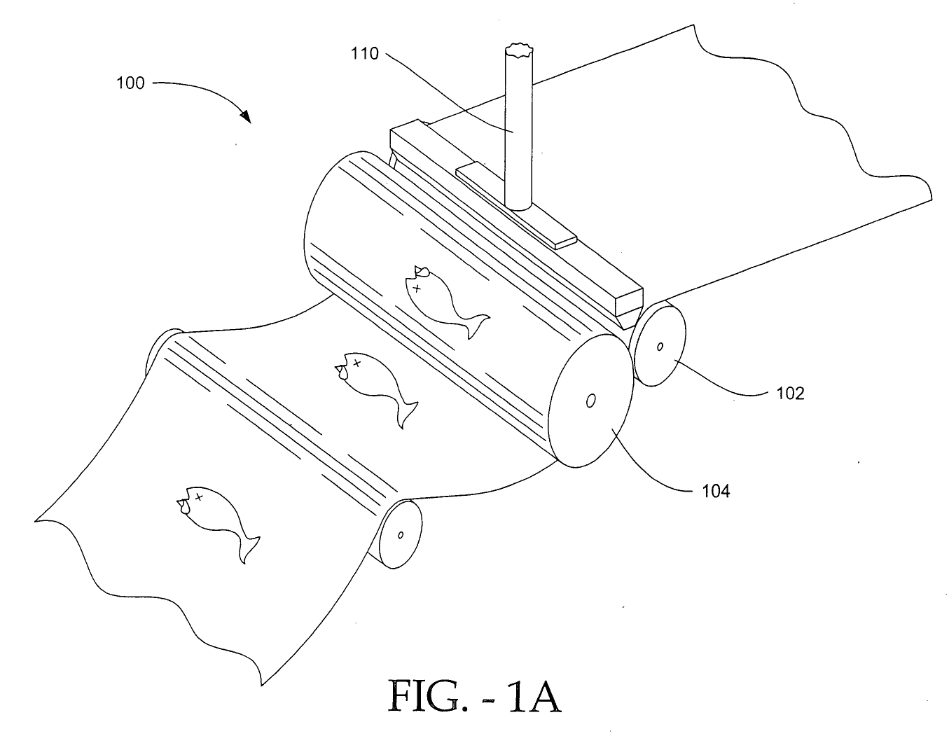

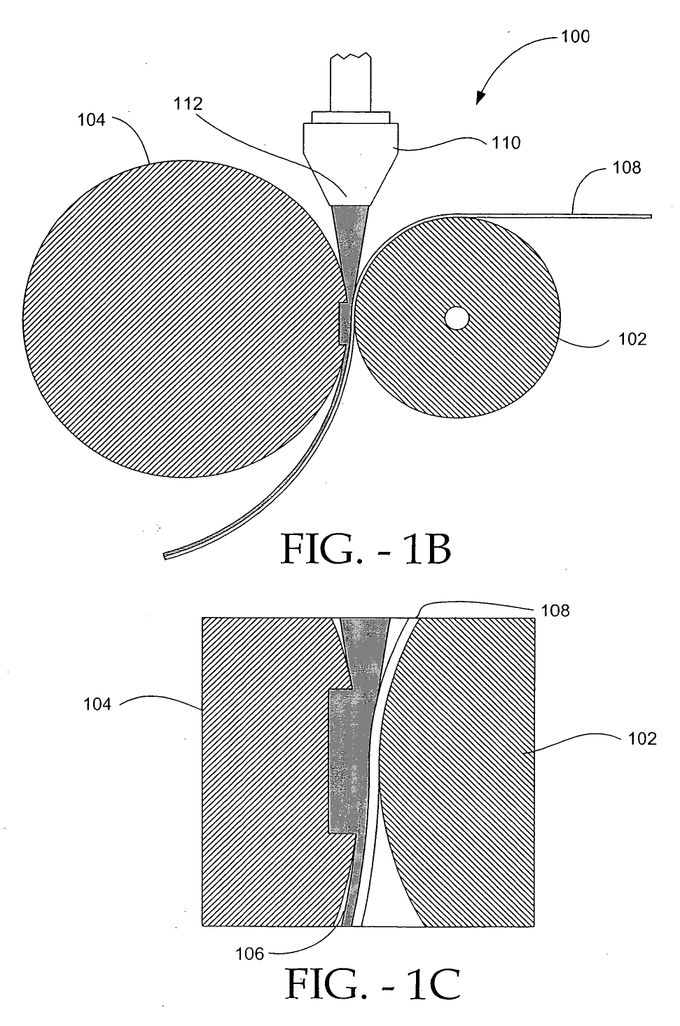

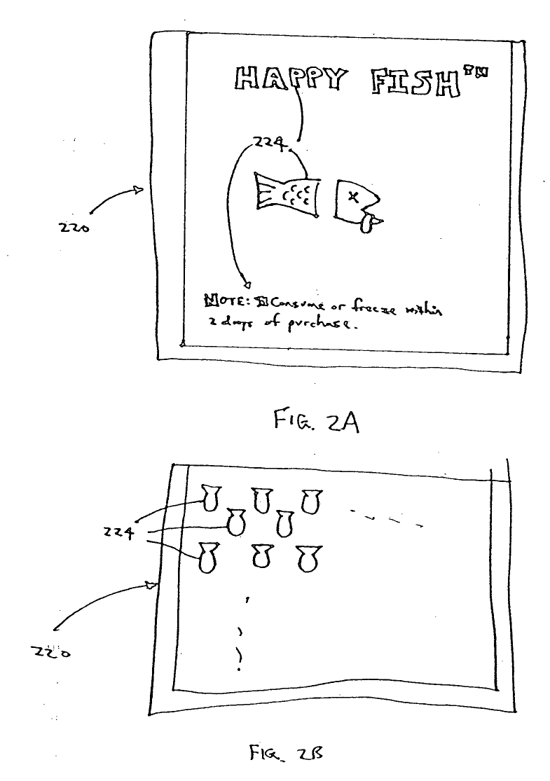

FIGS. 1A-1C illustrate one embodiment of a method for manufacturing a vacuum bag in accordance with the present invention. The vacuum bag comprises a first panel and a second panel, wherein each panel comprises a gas-impermeable base layer 108 and a heat-sealable inner layer 106 with at least one panel having indicia. A laminating roll 102 and a cooling roll 104 are arranged so that the heat-sealable inner layer 106 can be laminated to the gas-impermeable base layer 108 as the melt-extruded resin is cooled. As illustrated in FIG. 1B, the gap between the laminating roll 102 and the cooling roll 104 can be controlled according to specifications (for example, thickness) of a panel for use in vacuum packaging. The temperature of the cooling roll 104 is maintained in a range such that the melt-extruded resin is sufficiently cooled to form the desired pattem. For example, a temperature range of about −15° C. to about −10° C. can be sufficient to properly form the desired pattern. The temperature range of the cooling roll 104 can vary according to the composition of the resin, the composition of the gas-impemneable base layer 108, environmental conditions, etc. and can require calibration. Also, the cooling roll 104 can be sized to have a larger diameter than the laminating roll 102, thereby bringing the melt-extruded resin into contact with more cooled surface area. For example, the diameter of the cooling roll 104 can be about one-and-a-half to about three times as large (or more) as that of the laminating roll 102.

The heat-sealable inner layer 106 typically comprises a thermoplastic resin. For example, the resin can be comprised of polyethylene (PE) suitable for preserving foods and harmless to a human body. A vacuum bag can be manufactured by overlapping two panels such that the heat-sealable inner layers 106 of the two panels are brought into contact and heat is applied to a portion of the periphery of the panels to form an envelope. The thermoplastic resin can be chosen so that the two panels strongly bond to each other when sufficient heat is applied.

The gas-impermeable base layer 108 is fed to the gap between the cooling roll 104 and the laminating roll 102 by a feeding means (not shown). The gas-impermeable base layer can be comprised of polyester, polyamide, ethylene vinyl alcohol (EVOH), nylon, or other material having similar properties and capable of being used in this manufacturing process, and also capable of being heated. The gas-impermeable base layer 108 can consist of one layer, or two or more layers, and can be transparent so that indicia is visible through the gas-impermeable base layer 108. When employing a multilayer-structured base layer, it should be understood that a total thickness thereof is also adjusted within the allowable range for the total gas-impermeable base layer 108.

An extruder 110 is positioned in such a way that the melt-extruded resin is layered on the gas-impermeable base layer 108 by feeding the melt-extruded resin to the nip between the cooling roll 104 and the gas-impermeable layer 108. The resin is fed through a nozzle 112 of the extruder 110. The temperature of the melt-extruded resin is dependent on the type of resin used, and can typically range from about 200° C. to about 250° C. The amount of resin to be extruded into the laminating unit 100 is dependent on the desired thickness of the heat-sealable inner layer 106.

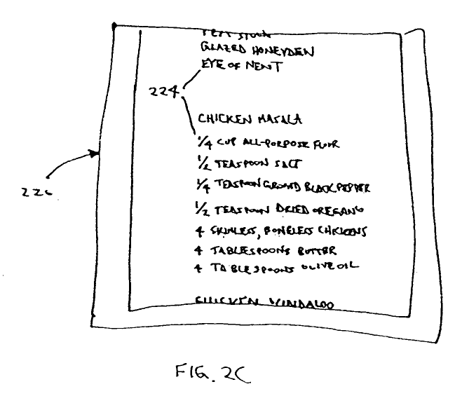

A pattern fabricated on the circumferential surface of the cooling roll 104 in accordance with one embodiment of the present invention can include protuberances and/or cavities or other pattern for forming indicia. The resin extruded from the nozzle 112 is pressed between the cooling roll 104 and the gas-impermeable base layer 108 and squeezed out where protuberances of the cooling roll 104 press into the resin, and/or the resin flows into the cavities of the cooling roll 104. The resin quickly cools and solidifies in the desired pattern while adhering to the gas-impermeable base layer 108, thereby forming the heat sealable inner layer 106 of the panel 220 as shown in FIGS. 2A-2E. The heat-sealable inner layer 106 can be formed while the resin is sufficiently heated to allow the resin to flow, thereby molding the resin, unlike other methods adopting a post-embossing treatment where the heat-sealable inner layer is drawn by a die or embossed between male and female components.

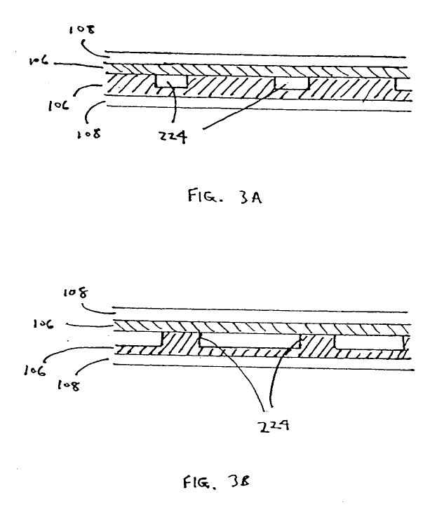

The depth (or thickness) of indicia formed on the heat-sealable inner layer 106 of a panel 220 can be determined by the height of the protuberances (or depth of the cavities) of the cooling roll 104. Thus, the shape, width, and depth (or thickness) of the indicia can be controlled by changing the specifications for the protuberances and/or cavities of the cooling roll 104. FIG. 3A illustrates a cross-section of two panels in accordance with one embodiment of the present invention wherein protuberances of the cooling roll 104 impress indicia into the melt-extruded resin. The heat-sealable inner layer 106 can range from 0.5-6.0 mils in thickness at the indicia, and 1.0-12.0 mils in thickness between indicia, while the gas-impermeable base layer 108 can range from about 0.5-8.0 mils in thickness. FIG. 3B illustrates a cross-section of two panels in accordance with an alternative embodiment of the present invention wherein the cavities of the cooling roll 104 form indicia on the inner layer 106. The heat-sealable inner layer 106 for this alternative embodiment can range from 0.5-6.0 mils in thickness between indicia and 1.0-80.0 mils in thickness at the indicia. The dimensions of the inner layer 106 and the base layer 108 are set forth to illustrate, but are not to be construed to limit the dimensions.

FIGS. 2A-2C are plan views of panels 220 formed by the cooling roll 104 for use in a vacuum bag, in which the heat-sealable inner layer 106 is molded in such a way that indicia 224 are formed on the heat-sealable inner layer 106. The indicia 224 can denote the intended contents of the bag, for example the indicia can resemble fish or poultry, etc. This can be useful for identifying the contents of a bag or for identifying pre-seasoned bags for marinating foods. Alternatively, the indicia 224 can be a trademark denoting the manufacturer or some other entity, for example. In other embodiments, the indicia 224 can be text, such as cooking or storing instructions or recipes. In still other embodiments, the indicia 224 can correspond to seasonal symbols such as snowmen or jack-o-lanterns. One of ordinary skill in the art can appreciate the different methods for communicating messages, both informative and whimsical.

The indicia 224 can also be used to improve a characteristic of the bag. For example, as shown in FIG. 2B, a pattern of protruding indicia 224 resembling fishes can be used to suspend contents such that liquid collects in the bag beneath the contents and between the indicia 224. The indicia 224 can also act as channels for the evacuation of air and/or other gases from the bag.

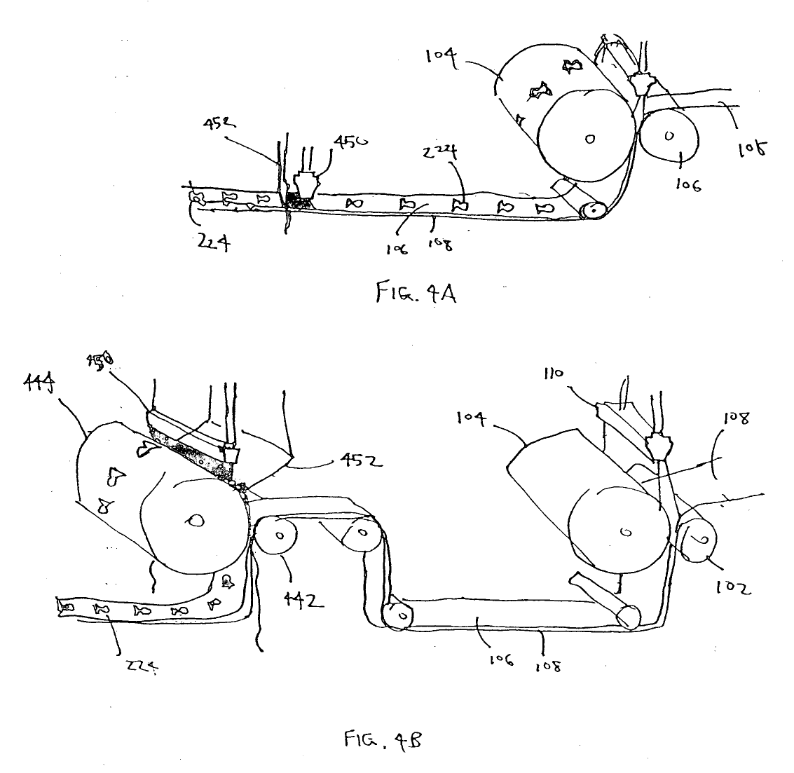

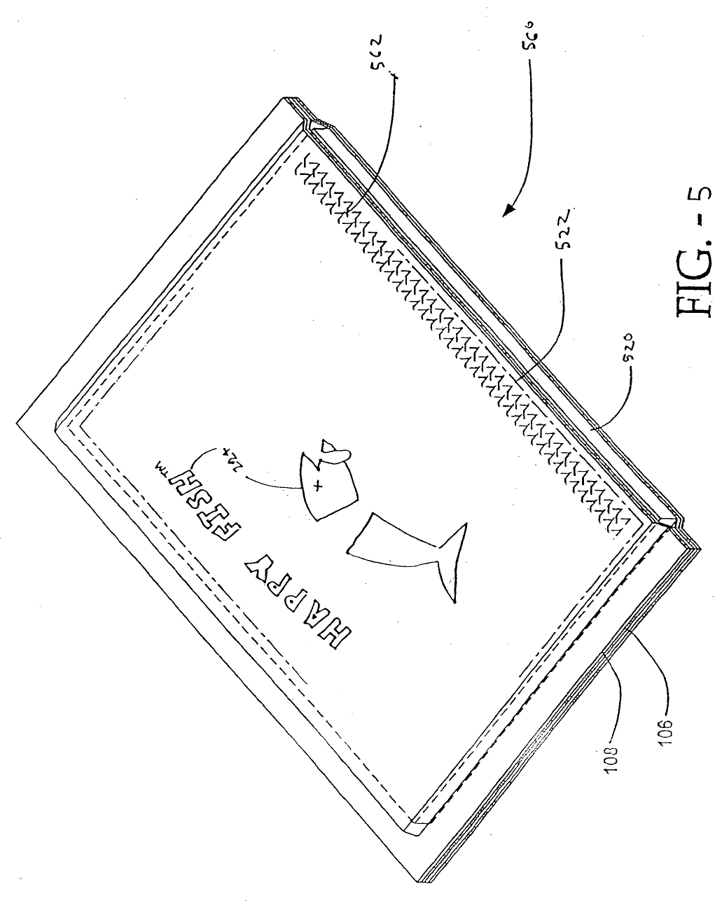

In other embodiments, the indicia 224 can comprise a thermoplastic resin, wherein the thermoplastic resin is dyed or colored as desired so that the indicia is visually more apparent to a user. The colored indicia 224 can be applied to the surface, for example, in a separate manufacturing step. In one embodiment, shown in FIG. 4A, indicia 224 imprinted as described above can be subsequently filled with dyed resin melt-extruded from a second extruder 450. Excess resin can be removed by a knife edge 452, and the panel can be cooled so that the dyed resin adheres to the heat-sealable inner layer 106, forming colored indicia.

In other embodiments, cavities and/or protuberances of the cooling roll 104 can include ink or dye so that indicia formed are colored by the ink or dye, while the melt-extruded resin surrounding the indicia is not colored by the ink or dye. The cavities and/or protuberances of the cooling roll 104 can be re-coated with ink or dye by a soft, saturated material mated to the cooling roll 104 as it rotates, thereby acting as an “inkpad” for the cooling roll 104. Alternatively, the ink or dye can be “sweated” into the cavities and/or protuberances through pores in the surface of the cavities and/or protuberances. One of ordinary skill in the art can appreciate the different methods for applying ink to grooves.

FIG. 4B illustrates yet another embodiment in which a first layer of melt-extruded resin can be laminated to the gas-impermeable layer 108 as described above, however without any pattern. Subsequently, the laminated film can be fed to a gap between a second cooling roll 444 and a second laminating roll 442, where a second extruder 450 feeds melt-extruded, dyed resin to the second cooling roll 444 having cavities corresponding to indicia 224. A knife edge 452 removes excess resin as the second cooling roll 444 rotates, and the still-cooling dyed resin adheres to the laminated film to form raised, colored indicia 224. Alternatively, the laminated film can be fed to an ink-jet printer, or other printing device. Accordingly, colored fish, for example, can be formed against a clear background or a background of another color.

FIG. 5 illustrates a bag for use in vacuum packaging in accordance with one embodiment of the present invention. The vacuum bag 560 comprises a first panel 520 overlapping a second panel 522. At least one indicia 224 is formed on at least one panel 520,522 in accordance with an embodiment described above. A panel 522,520 optionally includes channels 562 for evacuating air and other gases from the bag. The channels 562 can be formed, for example, along a portion of the panel as described in the cross-referenced application “LIQUID-TRAPPING BAG FOR VACUUM PACKAGING,” incorporated herein by reference. The heat-sealable inner layer 106 and the gas-impermeable base layer 108 of the first and second panels 520,522 are typically made of the same material respectively, but can alternatively be made ofdifferent materials that exhibit heat-sealability and gas-impermeability respectively. Additionally, at least one panel 520,522 can be transparent so that indicia is visible.

The features and structures described above can be combined with other manufacturing techniques to form a valve or other structure, tray, or integrated sensor, as described in the cross-referenced provisional applications, incorporated herein by reference. In other embodiments, the circumferential surfaces of the cooling rolls 104 described above can optionally include protuberances for forming perforations (not shown), such that a bag can be separated from a roll of bags by a customer.

As described above, the heat-sealable inner layer 106 is used as an inner layer and the gas-impermeable base layer 108 is used as an outer layer. The lower, left, and right edges of the first and the second panel 520,522 are bonded to each other by heating, so as to form an envelope for receiving a perishable or other product to be vacuum packaged. Once a perishable or other product is placed in the vacuum bag 560, air and/or other gases can be evacuated from the bag 560, for example by a vacuum sealing machine as described in the above referenced U.S. Pat. No. 4,941,310, which is incorporated herein by reference. Once the air and/or other gases are evacuated to the satisfaction of the user, the inlet can be sealed by applying heat, thereby activating the heat-sealable inner layers 106 and bonding them together where contacted by the heat.

The foregoing description of preferred embodiments of the present invention has been provided for the purposes of illustration and description. It is not intended to be exhaustive or to limit the invention to the precise forms disclosed. It is to be understood that many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for forming a panel for use in a sealable bag, comprising:
flowing a material onto a backing film, such that the flowing material is molded to form a structure;
wherein the structure is an indicia;
cooling the flowing material such that the flowing material solidifies to form an inner layer having the structure; and
wherein the inner layer adheres to the backing film.

2. A method for forming a bag adapted to receive an article, the bag being partially formed between a laminating roll and a cooling roll having a plurality of cavities for forming a structure, comprising:
feeding a gas-impermeable film to a nip formed by the cooling roll and the laminating roll;
extruding resin such that the resin fills the nip and the plurality of cavities exposed to the nip;
pressing the resin between the cooling roll and the laminating roll;
cooling the resin such that the resin forms the structure and adheres to the gas-impermeable film, forming a panel;
wherein the structure includes one or more indicia;
folding the panel such that a first portion of the panel overlaps a second portion of the panel; and
applying heat to a portion of a periphery of the first and second portions such that an envelope is formed.

3. A method for manufacturing a bag adapted to receive an article, comprising:
feeding a first gas-impermeable film to a first nip formed by a first cooling roll and a first laminating roll, the first cooling roll having a plurality of cavities for forming a structure;
wherein the structure includes one or more indicia;
extruding resin such that the resin fills the first nip and the plurality of cavities exposed to the first nip;
pressing the resin between the first cooling roll and the first laminating roll;
cooling the resin such that a first inner layer having the structure is formed;
wherein the first inner layer adheres to the first gas-impermeable film, thereby forming a first panel;
feeding a second gas-impermeable film to a second nip formed by a second cooling roll and a second laminating roll;
extruding resin such that the resin fills the second nip;
pressing the resin between the second cooling roll and the second laminating roll;
cooling the resin such that a second inner layer is formed;
wherein the second inner layer adheres to the second gas-impermeable film, thereby forming a second panel;
overlapping the first panel with the second panel; and
applying heat to a first, second, and third side of the first and second panels.

4. A method for manufacturing a bag adapted to receive an article, comprising:
rotating a first cooling roll at a first rate, the first cooling roll including one or more cavities for forming a structure having one or more indicia;
rotating a first laminating roll at a second rate;
introducing a first film to a first nip between the first cooling roll and the first laminating roll;
extruding molten material to the first nip;
pressing the molten material between the first cooling roll and the first film such that the molten material fills the plurality of cavities exposed to the first nip;
cooling the molten material such that a first inner layer is formed;
wherein the first inner layer includes the structure;
wherein the first inner layer adheres to the first film, thereby forming a first panel;
rotating a second cooling roll at a third rate;
rotating a second laminating roll at a fourth rate;
introducing a second film to a second nip between the second cooling roll and the second laminating roll;
extruding molten material to the second nip;
pressing the molten material between the second cooling roll and the second film such that the molten material fills the plurality of cavities exposed to the second nip;
cooling the molten material such that a second inner layer is formed;
wherein the second inner layer adheres to the second film, thereby forming a second panel;
overlapping the first panel with the second panel; and
applying heat to a portion of a periphery of the first and second panels such that the first panel and the second panel form an envelope.

5. The method of claim 4, wherein the second rate is an integer multiple of the first rate and the fourth rate is an integer multiple of the third rate.

6. The method of claim 4, wherein the first film and the second film comprise at least one layer.

7. The method of claim 6, wherein the at least one layer comprises a gas-impermeable material.

8. The method of claim 7, wherein the gas-impermeable material is one of polyester, polyamide, ethylene vinyl alcohol, and nylon.

9. The method of claim 4, wherein the molten material is polyethylene.

10. The method of claim 4, wherein a thickness of the first inner layer is determined by the size of the first nip and the thickness of the second inner layer is determined by the size of the second nip.

11. The method of claim 4, wherein the one or more indicia is information.

12. The method of claim 11, wherein the information is one or more recipes.

13. The method of claim 11, wherein the information is storage instructions.

14. The method of claim 11, wherein the information is a label identifying the article.

15. The method of claim 11, wherein the information is a trademark.

16. The method of claim 11, wherein the information is one of a name and a mark of an owner of the article.

17. The method of claim 4, wherein the indicia is a seasonal decoration.

18. The method of claim 4, wherein at least a portion of the indicia includes a surface having a color different than a color of the first and second panel.

19. A method of manufacturing a bag adapted to receive an article, comprising:
rotating a first roller having one or more recesses that can define one or more indicia;
rotating a second roller adjacent to the first roller, said second roller can feed a first film adjacent to the first roller;
applying a molten material between the first roller and the film;
said molten material filling the recesses of the first roller, and said molten material and film moving between the first roller and the second roller forming a first panel with a plurality of receptacles;
forming a second panel; and
mating the first panel to the second panel in order to form a bag.

20. The method of claim 18 including:
using a gas impermeable material for the film; and
using a heat sealable material for the molten material.

21. The method of claim 19, wherein said second panel is formed with the first roller and the second roller.

22. The method of claim 19, wherein said second panel is formed with the first roller and the second roller, and the mating step includes folding the first panel over the second panel.

23. The method of claim 19, wherein the one or more indicia is information.

24. The method of claim 23, wherein the information is one or more recipes.

25. The method of claim 23, wherein the information is storage instructions.

26. The method of claim 23, wherein the information is a label identifying the article.

27. The method of claim 23, wherein the information is a trademark.

28. The method of claim 23, wherein the information is one of a name and a mark of an owner of the article.

29. The method of claim 19, wherein the indicia is a seasonal decoration.

30. The method of claim 19, wherein at least a portion of the indicia includes a surface having a color different than a color of the first and second panel.
